(19) United States
(12) Patent Application Publication
(10) Pub. No.: US 2011/0187859 A1
(43) Pub. Date: Aug. 4, 2011

(54) Monitoring and camera system and method

(76) Inventor: Steven Donald Edelson, Wayland, MA (US)

(21) Appl. No.: 12/927,374

(22) Filed: Nov. 12, 2010

Related U.S. Application Data
(60) Provisional application No. 61/261,304, filed on Nov. 13, 2009.

(51) Int. Cl. H04N 5/235; H04N 7/18; H04N 5/335

(52) U.S. Cl. 348/143; 348/229.1; 348/294; 348/E05.037

(57) ABSTRACT

A monitoring system includes an image sensor configured to produce pixel data. An ambient light sensor such as a photocell produces ambient light level data. A processing subsystem is programmed to adjust the pixel data based on the ambient light level data. For example, the gain of an analog to digital converter can be increased or decreased based on the ambient light level data to adjust analog pixel data output by the imager as it is converted to digital data. If the ambient light level is high, for example, the gain can be decreased.

### RELATED APPLICATIONS

This application hereby claims the benefit of and priority to U.S. Provisional Application Ser. No. 61/261,304, filed on Nov. 13, 2009 under 35 U.S.C. §§119, 120, 363, 365, and 37 C.F.R. §1.55 and §1.78.

### FIELD OF THE INVENTION

The subject invention relates to camera based monitoring systems.

### BACKGROUND OF THE INVENTION

It is often desirable to monitor processes such as welding or metal cutting where a high energy electric arc, plasma, torch flame, laser, electron beam or other high energy source is used. The welding can be very bright and becomes the dominant illumination source for the area surrounding it illuminating the area to many times the brightness as would come from other lighting at the site. Using a darkened window does not always enable viewing of the feed stock, the liquid material pool, the tool tip, and the like.

It is also very difficult to capture the wide dynamic range of light during such processes using conventional cameras although a fairly wide dynamic range from the brightest to darkest details at the site can be captured by a logarithmic sensor. Exposure techniques include the global shutter and rolling shutter methods. The arc, in addition to being extremely bright, also changes in intensity so exposure of the site image can be uneven between rows in an image and between individual video frame images.

The known prior art is primarily limited to addressing lighting conditions which change in a predictable fashion, for example, when fluorescent lighting is used. In accordance with U.S. Pat. No. 7,667,740, incorporated herein by this reference, a rolling shutter sensor is used and sensor pixel data is processed to produce a set of images from which the light modulation frequency is determined. Then, once the light modulation frequency is determined, the exposure time of the image sensor is synchronized to the modulation frequency. See also U.S. Pat. Nos. 5,706,416; 5,828,793; 6,208,433; 6,771,305; 7,030,923; 7,298,401; 7,675,552; and Patent Application Publication Serial Nos. 2003/0030744; 2006/0158531; 2010/0045819; and 2008/0192819 all incorporated herein by this reference.

The result can be a relatively long exposure which can be problematic. Also, this technique is based on the assumption that the light variation is periodic which is not necessarily true in some environments including arc welding.

### BRIEF SUMMARY OF THE INVENTION

It is therefore an object of the subject invention to provide accurate correction of image and row variation due to changing ambient light for imaging sensors in both the global and rolling shutter modes. In one aspect, a monitoring system is provided which, instead of determining information about the lighting conditions from the image data uses, in one preferred embodiment, a fast photocell which gathers ambient light and which is sampled at a rate sufficient to give an accurate estimate of the lighting conditions during exposure of the image sensor. This information is used to adjust the pixel data output by the image sensor. If the image sensor is non-integrating, then the light levels are sampled at the same instant as the frame (if a global shutter) or the row (if a rolling shutter) is exposed. If the sensor is a traditional integrating sensor, then the ambient light is sampled at a rate sufficient to add the samples during the integration time and estimate the total light falling on the scene or at the site during the integration time of the row, for rolling shutters, or for the image integration time, for global shutters. With an estimate of the illuminating light at the site, the image sensor pixel data is adjusted (corrected) in advance of shifting out the pixels in order to mitigate the change due to the changing light, caused, for example, by an arc. The illumination data and the mitigating settings can be retained and forwarded with the digitized data to enable further corrections to the digital data downstream (for example, in accordance with prior art techniques).

The invention features a monitoring system for a site where welding or the like occurs. An image sensor is configured to produce pixel data, an ambient light sensor outputs ambient light level data, and a processing subsystem is configured to adjust the pixel data based on the ambient light level data.

The image sensor may be an integrating sensor or a non-integrating sensor. The processing subsystem can be configured to acquire pixel data form the image sensor according to a rolling shutter method or a global method. Typically, the ambient light sensor includes at least one photocell, photodiode, or the like.

In one example, the processing subsystem includes a processor configured to control the image sensor to capture the pixel data which is provided to the processor. In one version, a circuit has an adjustable gain and/or an adjustable offset responsive to analog pixel data output produced by the image sensor and the processing subsystem is configured to adjust the gain and/or offset based on the ambient light level data. The circuit may include an analog to digital converter. In another version, the processing subsystem is configured to adjust pixel values as a function of one or more calibration constants derived from calibration pixel data and ambient light level data.

The processing subsystem can be configured to sample ambient light level data from the ambient light level sensor simultaneously with exposure of the pixel data. Also, the processing subsystem can be configured to initiate exposure of the image sensor, read the ambient light level data from the ambient light level sensor until a predetermined amount of light energy has been measured by the ambient light level sensor, and then end the exposure of the image sensor.

One camera system in accordance with the invention includes a non-integrating sensor aimed at a site and including an array of pixels exposed according to a predetermined sequence producing analog pixel data. A photocell outputs ambient light level data during exposure of the pixels. A converter circuit with an adjustable gain and/or adjustable offset is responsive to the analog pixel data and a processing subsystem is configured to adjust the gain and/or offset of the converter circuit based on the ambient light level data to correct the pixel data for varying ambient lighting at the site. A video processing subsystem is responsive to the corrected pixel data and is configured to produce video images for display in order to monitor the site. One camera system in accordance with the invention features a non-integrating image sensor including an array of pixels which produce analog pixel data. A circuit with an adjustable gain and/or adjustable offset is responsive to the analog pixel data as it is produced. A processing subsystem is configured to adjust the gain and/or offset of the circuit to correct the analog pixel data. In one preferred embodiment, an ambient light level sensor produces ambient light level data and the processing subsystem is configured to adjust the gain and/or offset of the circuit based as a function of the ambient light level data.

The invention also features a method of using an image sensor to produce analog pixel data, using an ambient light sensor to produce ambient light level data, and adjusting the analog pixel data based on the ambient light level data. Adjusting the pixel data may include adjusting the gain and/or offset of the analog pixel data. Pixel values are output by the image sensor for various ambient light levels and calibration constants are then calculated based on the pixel and ambient light level values. Adjusting the analog pixel data includes adjusting pixel values based on the calibration constants.

The ambient light level data can be sampled simultaneously with the capture of the pixel data. Also, exposure of the image sensor can be initiated, the ambient light level data can be read until a predetermined amount of light energy has been measured, and then the exposure of the image sensor can be stopped.

A method of monitoring a site in accordance with the invention features aiming an imaging sensor at the site and exposing pixels of the sensor according to a predetermined sequence to produce analog pixel data. A photocell or other device is used to produce ambient light level data during each exposure of the pixels. The gain and/or offset of the analog pixel data is adjusted based on the ambient light level data to correct the analog pixel data for varying ambient lighting at the site. The method may further include producing video images for display based on the corrected pixel data.

An imaging method in accordance with one aspect of the invention features producing analog pixel data by exposing an array of pixels of a non-integrating image sensor according to a predetermined sequence or by exposing the pixels simultaneously and adjusting the gain and/or offset of the analog pixel data as it is produced. Typically, the gain and/or offset of the analog pixel data is adjusted based on ambient light level produced by an ambient light level sensor.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view showing an array of sensor pixels;

FIG. 2 is a graph showing light intensity as a function of fluorescent illumination in accordance with the prior art technique of U.S. Pat. No. 7,667,740;

FIG. 3 is a block diagram showing the primary components associated with a camera system in accordance with the subject invention;

FIG. 4 is a block diagram showing the primary components associated with a camera subsystem for one particular embodiment of a camera system in accordance with the subject invention;

FIG. 5 is a schematic block diagram showing the primary components associated with another embodiment of a camera system in accordance with an example of the invention; and

FIG. 6 is a graph showing the effects of gain and offset correction in varying ambient light.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

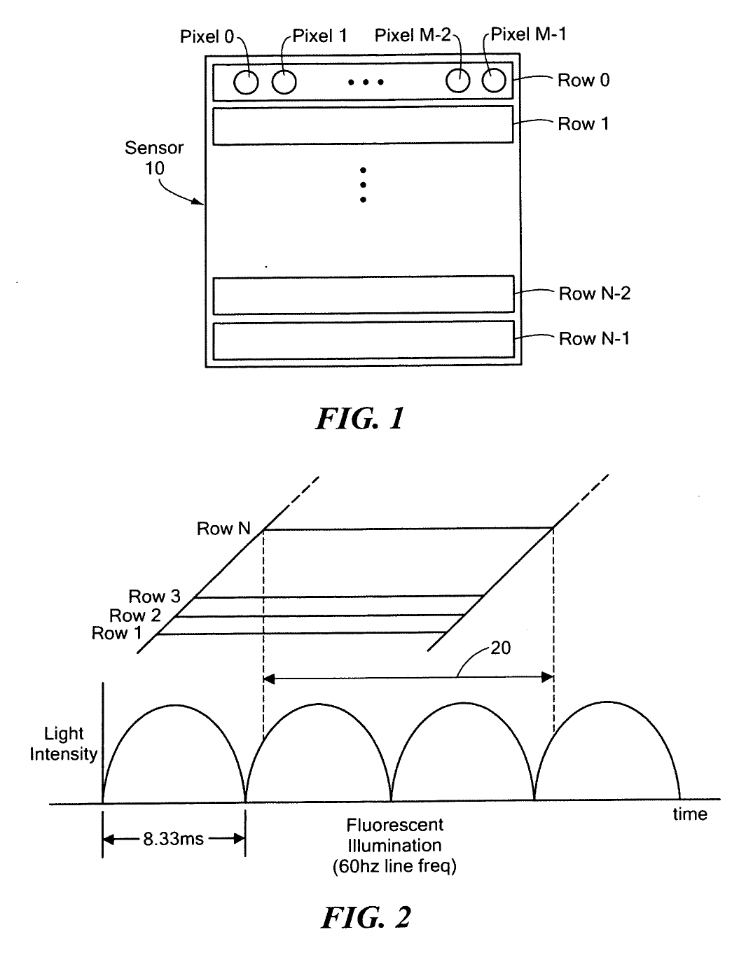

FIG. 1 depicts an example of an image sensor 10 including rows and columns of pixels. There are N rows each containing M pixel locations. The pixel data is usually read out sequentially left to right along a row, row by row, top to bottom, or the like. Internally, the pixel light sensing elements collect charge or voltage which can be digitized within the sensor integrated circuitry or with an external analog to digital converter. Examples of logarithmic sensors exhibiting a wide dynamic range and thus useful in the subject invention include the NSC0806 or NSC1001 from New Image Technology of Evry, France or the HGR sensor line from Institut fur Mikroelektronik of Stuttgart Germany such as the one used in the HDRC-VGAD.xCL camera. Other CMOS sensors or CCD sensors can also be used.

Image sensors record light in two common ways. The majority are exposed for a period of time and integrate charge into a capacitor in proportion to the light intensity. Such sensors are typically deemed “integrating image sensors.” Commercial logarithmic image sensors do not integrate, but are voltage sampled at a point in time and are deemed “non-integrating image sensors.” In accordance with the subject invention, non-integrating sensors and/or integrating sensors can be used but since common commercially available logarithmic sensors are non-integrating, non-integrating sensors are therefore preferred.

Some sensors, such as the NSC0805, employ a rolling shutter technique where individual horizontal lines of the image are exposed in sequence. Others, such as the NSC 1001 employ a global shutter technique where every pixel in every row of the image is exposed simultaneously. In accordance with the subject invention, the monitoring system or camera system may employ the rolling shutter or global shutter technique.

As discussed in the Background section above, when the lighting of a scene or site is constant, then the sensor readings are the same no matter when they are exposed. However, if a light source is changing, the exposure can be uneven between rows and individual video frame images. This occurs in consumer video when fluorescent lighting is used. U.S. Pat. No. 7,667,740 adjusts the exposure time as shown at 20 in FIG. 2 to span full cycles of the fluorescent light so that every lines gets the same total light as shown. This technique results in a relatively long exposure time which can be problematic with intense light like that found in arc welding. The technique also requires a periodic light variation which may not be true in processes such as arc welding.

For global shutter sensors, the exposure time can be an integer multiple of the lighting period like the rolling shutter, but a long exposure time is necessary as is a periodic and predictable light. Global shutters can have shorter exposure times, if the light is predictable and periodic. If the exposure is phase-synced to the light wave pattern, it will span the same phase of the light cycle, resulting in equal exposures.

Non-integrating, logarithmic sensors, useful for arc welding light because of their wide dynamic range, do not have an exposure time. They sample the light in an instant and save the results for sequential readout. If they have a global shutter, the whole image exposure will vary with the sample time. However, if the sampling is constrained to be at the same point in the cycle, uniform illumination can be had. This synchronization will remove the flicker, but relies on a periodic lighting and sets constraints on the frame rate of the camera.

The rolling shutter non-integrating camera has a more difficult situation. It is not practical to space the row samples at equal height points along a waveform as this would set an unacceptably slow row rate (e.g., 120 rows per second).

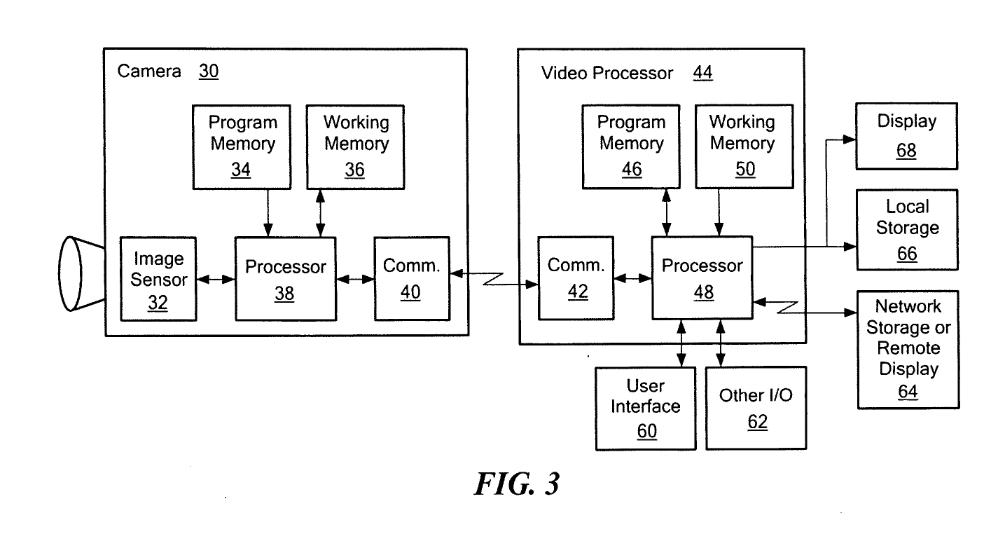

FIG. 3 shows a block diagram for an exemplary system which implements the invention. It includes two main subsystems, camera 30 and video processor 44. The camera is responsible for gathering the images via image sensor 32 under the control of processor 38. The processor program may reside in program memory (e.g., ROM) 34 and processor 38 has access to working memory (e.g. SRAM) 36. Under program control, processor 38 gathers the images and performs basic image processing and formatting. Communication of the images as well as control and status information is performed by port 40 (e.g., a USB).

In common cameras, processor 30 outputs the video image sequence with little processing. The images are typically processed in video processor 44.

Video processor 44 is typically a PC-class computer with similar functional blocks as those of the camera, including communications module 42 (e.g., a USB), processor 48 (e.g., Intel Pentium), program memory 46 (e.g., Disk Drive) and working memory 50 (e.g., DRAM). Typically, a PC-class computer has much more memory and much higher processing capability than the counterparts in the Camera.

Video processor 44 can optionally have a user interface 60 (e.g., keyboard, touch-screen) and other I/O 62 such as USB or industrial dry-contact closure. The output of the video processor is a stream of video images which may be displayed on display 68 (e.g., a computer monitor) or stored locally or sent to remote storage or display 64 over a network such as a LAN or the Internet.

In the prior art, as discussed above, analog pixel data produced by image sensor 32 is digitized, processed by processor 38, and transmitted to video processor 44 including processor 48. Processor 38 and/or processor 48 typically determines the ambient light level based on the digital image.

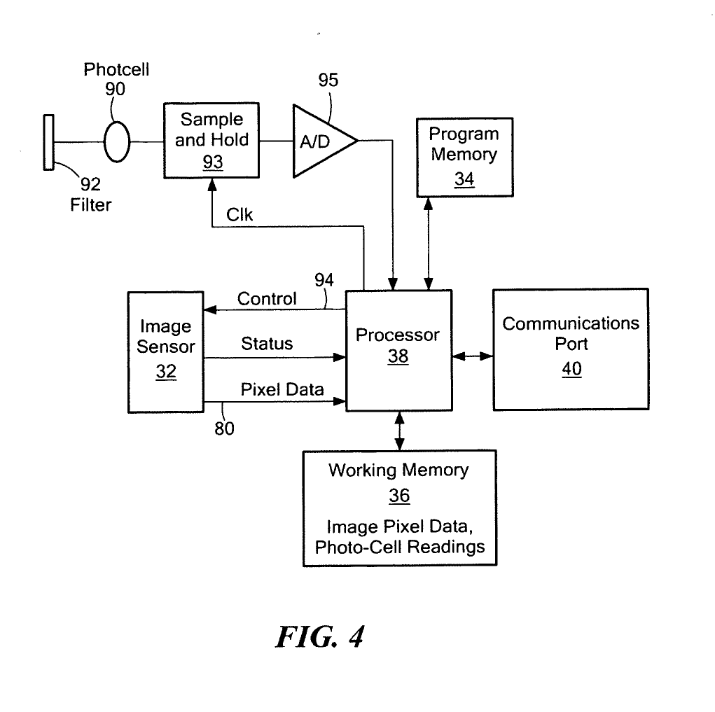

In accordance with an example of the subject invention, in contrast, pixel data from image sensor 32, FIG. 4 as shown at 80 is adjusted based on ambient light level data as determined by an ambient light sensor such as photocell, photodiode, phototransistor or other suitable light sensor, 90. Filter 92 may be provided as discussed below. Image sensor 32 is preferably a non-integrating CMOS sensor but could also be of another technology including non-integrating CCD, integrating CCD, or integrating CMOS sensors. The image sensor is typically aimed at a site such as the site of a welding or cutting operation. An operator can view video of the processing site using user computer display 68. Processor 38, FIG. 4 can be programmed to control image sensor 32 as shown at 94 according to the rolling shutter method or the global method, as discussed above.

Ambient light sensor 90 can be mounted on the front of the camera, roughly facing the direction of the camera image. Diffuser-filter 92 allows a broad angle of light correction so the ambient light sensor reads the ambient light. Arc welding light illuminates the entire scene so any flicker in the arc will dominate the light both directly hitting the ambient light sensor as well as being reflected to the ambient light sensor from various directions. Diffuser-filter 92 can be tinted. To extend the light range input, multiple ambient light sensors with differently darkened filters can be used. Hardware can also be used to gauge the variation in the arc light and allow in-computer compensation. A single fast-response light sensor can be used to digitize the overall light over the course of the camera exposure. To allow fine-grain correction, the light can be digitized at a very high rate to allow knowledge of the brightness during the different time slices within the exposure time. Ambient light sensor 90 can be used for overall exposure control. Because of the freedom of technology choice and size, the range of an ambient light sensor can be wider than that of the imaging pixels.

The smallest exposure time, and the smallest subset of an exposure for multi-slope in common sensors, such as the Cypress Ibis-5, are approximately 40 μsec, indicating that the capture rate from the light sensor should be faster than this to resolve changing light. Modern electronics run much faster than this, making faster ambient light sensor digitizing times of 10 μsec or even 1 μsec quite practical.

Although a single, discrete, light sensor has a good dynamic range, it is worth noting that the range for the light is very wide and may be too wide to record with a single sensor. In this case, multiple ambient light sensors, with appropriate attenuating filters can be used, simultaneously, to cover the very wide range. It is anticipated that three synchronized, common photo-sensors can produce more than enough range. In one embodiment, the three sensors would have filters as follows: one with no filter, one with a single ND2 neutral density filter (1% transmission) and one with an ND4 neutral density filter (0.01% transmission).

If the ambient light sensor response is non-linear, it can be measured at installation and a compensation circuit can be used or a compensation digital look-up-table (in the camera or in the video processor) can be used to linearize the result. Other ambient light sensors such as photodiodes, phototransistors, or the like may be used.

In FIG. 4, the output of the ambient light sensor is digitized by analog to digital converter 95 and is provided to processor 38. Processor 38 also controls the image sensor 32 and is provided with complete status of the timing of the sensor, allowing the processor to correlate the readings of the ambient light sensor with the time when the image was exposed.

For a non-integrating sensor, processor 38 receives the ambient light sensor reading that corresponds to the exposure point in time of each row of a rolling shutter sensor or corresponding to the exposure time of the entire array for a global shutter sensor.

If the sensor is a traditional integrating sensor, processor 38 integrates the ambient light sensor readings that come in during the exposure period, just as the sensor pixel circuit will integrate the light. To provide ample accuracy in the integration, the processor should sample the ambient light sensor level eight or more times during the “exposure period”. If image sensor 32 is a rolling shutter sensor, the exposure period is that of each row. If image sensor 32 is a global shutter sensor, the exposure period is that of the global image.

These ambient light sensor readings can be stored in the working memory 36 along with the matching image pixel data. The ambient light sensor readings, as discussed above, provide information to aid the correction of the image pixel data. The correction calculation can be performed in the camera processor 38 or the ambient light sensor readings can be sent, along with the image pixel data through communications port 40 for correction in video processor 44, FIG. 3.

The correction can be done by equation or look-up table. A look-up table would contain pre-computed output pixel value for each pairing of input pixel value and ambient light sensor reading. The look-up table contents can be created to achieve an accurate mathematical correction or can be otherwise calculated and adjusted to the preference of viewers.

An accurate correction can be generated from data gathered in a calibration test bed or in actual operation with the following procedure.

With the camera focused on an un-changing scene containing a variety of pixel brightness and with ambient light varying over the relevant range, a series of readings of the ambient light sensor data can be taken to establish the range of the ambient light level as measured by the ambient light sensor 90, held by the sample and hold 93 and digitized by the analog to digital converter 95.

With the ambient light range established, an ambient light brightness is chosen as the standard ambient light point. This would typically be near the midpoint of the ambient light range, but others could be chosen. This chosen ambient light brightness will be used as the standard to which other ambient light levels will be indexed and corrected. The next step is to get readings of a variety of pixel brightness at the chosen standard ambient light. If a test fixture is used, the ambient light may be explicitly set. If the calibration is being done in-operation, the calibration is run in an opportunistic mode, taking a series of readings over time and waiting for the opportune exposure at the standard ambient level. This capture might be one or more lines if it is a rolling shutter, or an entire image if a global shutter.

With the standard pixel values stored, the system continues to capture those same image pixels at other ambient levels. Repeatedly capturing the same pixels allows direct comparison of the pixel data to quantify changes due to the ambient light change. One calibration method is to use brute-force, sampling every possible pixel value under every possible ambient light level to explicitly populate a look-up table.

However, this is not necessary. Response curves can be characterized at varying ambient levels allowing for conversion parameters and equations to do the equalization. Further, it is not necessary to sample every ambient light level since well-chosen curve fit parameters will be mathematically well behaved and can be interpolated to generate parameters for missing ambient light sensor levels.

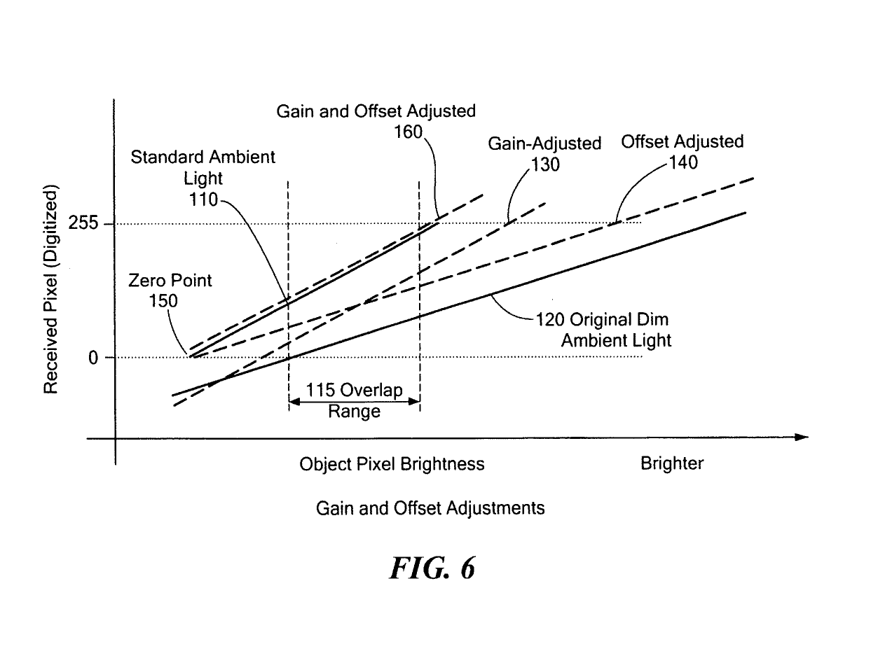

The equations can be used by the processor 38 to calculate a corrected pixel value, or the equations could be used to pre-compute a complete look-up table for run-time use. FIG. 6 shows a graph of received, digitized pixel values from the image sensor 32 as a function of the object pixel brightness.

The solid line 110 represents the pixel data, at the standard ambient light. If the object which is the subject of the pixel is too dark, the pixel value clips to zero. Likewise if the spot is too bright, the pixel value will clip to the maximum value (255, assuming an 8-bit sensor). In-between is a sloped range where the received pixel value varies in relation to the object brightness. This is sometimes called the “active range” or “linear range” of the sensor and analog to digital converter.

Line 120 shows the same object pixels with darker ambient light. Because the light is dimmer, the range of object brightness is shifted down. In addition to the downward shift, the slope of the active area is lower in the dim ambient light than the slope in the standard ambient light.

These two curves (110 and 120) represent two responses to the same physical scene, given a change in the ambient light. There is a zone of overlap, 115, where pixels have valid (non-clipped) values in both lighting conditions. By comparing these pixels, with a linear regression, we can compute the relative slopes of the two curves as well as the relative offset.

The calculation is a simple linear regression to find the ratio (slope) and offset (intercept) considering the Standard exposure as “X” and the other exposure as “Y”:

The calculation in one preferred embodiment is:
SumStandard=sum (ValidPixelsValuesInStandardExposure)
SumOther=sum (ValidPixelsValuesInOtherExposure)
SumCrossProduct=Sum (Standard(i) * Other(i))//“i” is a location of valid pixel pair
SumStandardSquared=Sum (Standard(i) *Standard (i))//“i” is a location of valid pixel pair
StandardAverage=SumStandard/CountOfValidPixels;
OtherAverage=SumOther/CountOfValidPixels;
tempNumerator=SumProduct-(SumStandard * OtherAverage);
tempDenominator=SumStandardSquared-(SumStandard * StandardAverage);
Slope=tempNumerator/tempDenominator;
Intercept=OtherAverage-(StandardAverage * Slope);

This linear equation “fits” the two curves of different ambient light levels using a linear relationship. Higher order polynomials can, alternatively, be used to fit the curves if desired.

If the ambient levels are far apart, there may be too few overlapping sample pixels to have a valid calculation. To avoid this, modest ambient level changes are compared and calculated. These relative readings of modest ambient light level changes are then combined, using algebra, to calculate the net slope and offset values from more distant ambient light levels back to the Standard Ambient level.

A complete table of slope and intercept for each ambient light level allows conversion of an observed pixel level at any ambient light level to the equivalent pixel value at the standard ambient light level. Ambient light levels which are not explicitly measured can be given estimated slope and intercept values based on interpolation, extrapolation or other curve-fit approximations of the slope and intercept of measured ambient light levels.

These factors, slope and offset, translate an input pixel into an approximated output pixel at the standard ambient light sensor reading using the equation, S=I*m(A)+b(A)

### Where:

S: Standard Ambient Light Pixel Value

I: Input Pixel Value (from Sensor)

A: Ambient Light Reading

m(A): Multiplier for this value of “A”

b(A): Offset for this value of “A”

The line 140, FIG. 6 shows the effect of adding the offset correction b(A) to the pixel data in dim ambient light, line 120. This retains the slope of line 120, but moves the line upward so that the zero point of the corrected line 140 agrees with the zero point of the standard ambient light data 150. Line 130 shows the effect of multiplying the original dim ambient light data 120 by the gain correction m(A). The corrected slope matches that of the standard ambient light data 150. Using both adjustments results in dashed line 160 which is substantially identical to the original ambient light data curve 150—the desired result.

Accordingly, in this embodiment, processor 38 is configured to adjust pixel values as output by image sensor 32 and acquired by processor 38 as a function of one or more calibration constants derived from calibration pixel and ambient light level data. A processing subsystem which adjusts the pixel data in this way can be processor 38, FIG. 3, processor 48, or a combination of these or equivalent processors or other controllers or electronic subsystems.

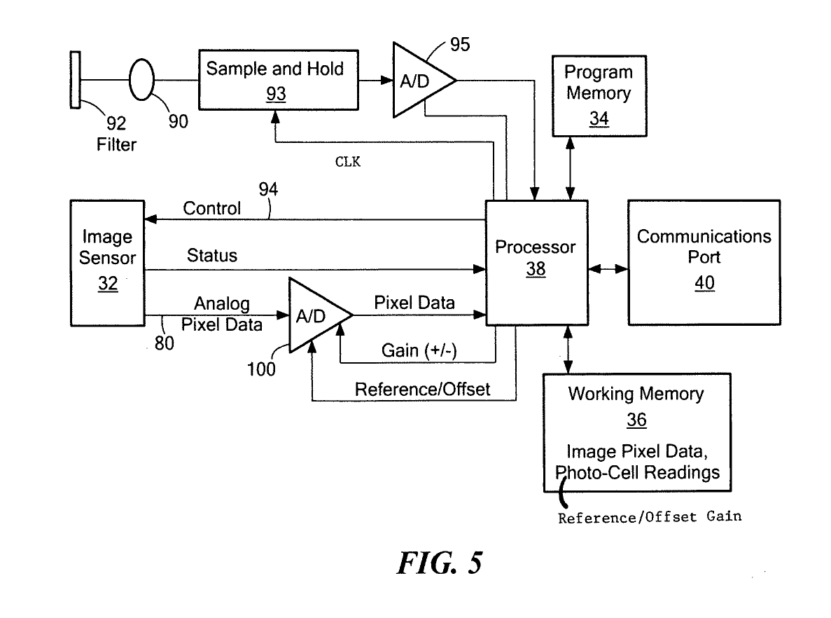

Another subsystem is shown in FIG. 5. Here, the linear correction parameters m(A) and b(A) are used to set the analogous analog control parameters of gain and offset (respectively). This dynamic adjustment of the analog pixel data signal before digitization can preserve significant information in the analog signal that would be lost if gain and offset were not compensating to scale and offset the analog signal.

Because the shift-out of pixel data happens after the completion of exposure, the processor 38 is provided with the ambient light level data from the ambient light sensor 90 and can calculate the required gain and offset settings before the first pixel data comes out of sensor 32.

The correction is not based on predicted ambient light, like the prior art; instead it is based on actual measured light for the pixels about to shift out of the sensor.

The result of the analog correction will be a digital result similar to that calculated as discussed above in relation to FIG. 4, but with better intensity resolution and range. This digitized result can be further corrected in software or look-up table if higher-order corrections are desired. The result includes correction of analog pixel data in a way that is not dependent upon a periodic ambient light variation.

In FIG. 5, analog to digital converter circuit 100 may be a separate circuit as shown or may be within the sensor 32 with one or both external control inputs, the analog to digital converter 100 may also be within the processor 38. The location of the analog to digital converter does not change the spirit of the invention. The converter may have the necessary inputs for gain and offset (perhaps an external V-Ref). If the converter does not have these inputs, appropriate summing and multiplying analog circuits could be inserted between the sensor output and the input to the converter in order to pre-condition the analog signal. In any case, at some point, the image sensor produces analog pixel data.

The settings of gain and offset used for the converter would be typically stored in working memory 36 along with the pixel data and the ambient light sensor readings so that down-stream processing (perhaps in video processor 44, FIG. 3), could factor this data into any further correction calculation.

Accordingly, in this particular embodiment, a converter circuit such as analog to digital converter 100 includes an adjustable gain and/or adjustable offset and is responsive to analog pixel data as shown at 80 output from image sensor 32. A processing subsystem, typically including processor 38, is configured, (e.g., programmed) to adjust the gain and/or offset of the converter circuit based on the ambient light level data output from device such as ambient light sensor 90.

Ambient light sensor readings can also be used to actively adjust the exposure times of an integrating image sensor as they are being exposed (under the control of processor 38). In this mode, the ambient light sensors would not only be used to record the brightness during the exposures, but would tie into the camera's exposure trigger to terminate the exposure when the required light has been received. This would be applied to each of the exposure times to try to keep them in the desired light ratios instead of time ratios. For example, if two exposures were scheduled with expected times of 1 μsec and 10 μsec, assume that the first exposure was completed at 1 μsec, with a measured average brightness of “X.” If the 10 μsec exposure recorded while the light brightened to an average brightness of “2X,” the readings from the ambient light sensor would be integrated as the exposure progressed. At 5 μsec, the integrated readings would indicate that the 10:1 ratio had been reached and the exposure would be terminated when 5 μsec elapsed maintaining the desired 10:1 ratio to the first 1 μsec exposure. This function would be helpful in multi-image high-dynamic-range imaging applications where multiple images, taken at different exposure levels, are composited into a single image taking the best exposure data for each pixel from the set of available images.

Specific features of the invention may be shown in some drawings and not in others but this is for convenience only as each feature may be combined with any or all of the other features in accordance with the invention. Also, the words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A monitoring system comprising:
an image sensor configured to produce pixel data;
an ambient light sensor outputting ambient light level data; and
a processing subsystem configured to adjust the pixel data based on the ambient light level data.

2. The system of claim 1 in which the image sensor is a non-integrating sensor.

3. The system of claim 1 in which the image sensor is an integrating sensor.

4. The system of claim 1 in which the image sensor employs a rolling shutter.

5. The system of claim 1 in which the image sensor employs a global shutter.

6. The system of claim 1 in which the ambient light sensor includes at least one photocell, photodiode, or phototransistor.

7. The system of claim 1 in which the processing subsystem includes a processor configured to control the image sensor to capture said pixel data which is provided to the processor.

8. The system of claim 1 further including a circuit with an adjustable gain and/or adjustable offset responsive to analog pixel data produced by the image sensor.

9. The system of claim 8 in which the processing subsystem is configured to adjust the gain and/or offset based on the ambient light level data.

10. The system of claim 8 in which the circuit includes an analog to digital converter.

11. The system of claim 1 in which the processing subsystem is configured to adjust a pixel value as a function of one or more calibration constants derived from calibration pixel data and ambient light level data.

12. The system of claim 1 in which the processing subsystem is configured to sample ambient light level data from the ambient light level sensor simultaneously with exposure of the pixel data.

13. The system of claim 1 in which the processing subsystem is configured to initiate exposure of the image sensor, read the ambient light level data from the ambient light level sensor until a predetermined amount of light energy has been measured by the ambient light level sensor, and then end the exposure of the image sensor.

14. The system of claim 1 wherein the image sensor is aimed at a site where a high energy light is present.

15. A camera system comprising:
a non-integrating sensor aimed at a site and including an array of pixels exposed according to a predetermined sequence producing analog pixel data;
a light sensor outputting ambient light level data during exposure of said pixels;
a circuit with an adjustable gain and/or adjustable offset responsive to the analog pixel data;
a processing subsystem configured to adjust the gain and/or offset of the converter circuit based on the ambient light level data to correct the pixel data for varying ambient lighting at the site; and
a video processing subsystem responsive to the corrected pixel data and configured to produce video images suitable for display in order to monitor the site.

16. The system of claim 15 in which the circuit includes an analog to digital converter.

17. The system of claim 15 in which the processing subsystem is configured to sample ambient light level data from the ambient light level sensor simultaneously with exposure of the pixel data.

18. A camera system comprising:
A non-integrating image sensor including an array of pixels exposed according to a predetermined sequence or exposed simultaneously and producing analog pixel data;
a circuit with an adjustable gain and/or adjustable offset responsive to the analog pixel data as it is produced; and
a processing subsystem configured to adjust the gain and/or offset of the circuit to correct the analog pixel data.

19. The camera system of claim 18 further including an ambient light level sensor producing ambient light level data, the processing subsystem configured to adjust the gain and/or offset of the circuit based as a function of the ambient light level data.

20. The system of claim 19 in which the ambient light sensor includes at least one photocell, photodiode, or phototransistor.

21. The system of claim 18 in which the processing subsystem includes a processor configured to control the logarithmic image sensor to capture said analog pixel data which is provided to the processor.

22. The system of claim 18 in which the circuit includes an analog to digital converter.

23. The system of claim 19 in which the processing subsystem is configured to adjust an analog pixel value as a function of one or more calibration constants derived from calibration pixel data and ambient light level data.

24. The system of claim 19 in which the processing subsystem is configured to sample ambient light level data from the ambient light level sensor simultaneously with exposure of the pixel data.

25. A method comprising:
using an image sensor to produce analog pixel data;
using an ambient light sensor to produce ambient light level data; and
adjusting the analog pixel data based on the ambient light level data.

26. The method of claim 25 in which adjusting the pixel data includes adjusting the gain and/or offset of the analog pixel data.

27. The method of claim 25 further including determining a pixel value output by the image sensor for various ambient light levels and determining calibration constants based on the said pixel and ambient light level values and wherein adjusting the analog pixel data includes adjusting pixel values based on the calibration constants.

28. The method of claim 25 in which the ambient light level data is sampled simultaneously with exposure of the pixel data.

29. The method claim 25 in which exposure of the image sensor is initiated, the ambient light level data is read until a predetermined amount of light energy has been measured, and then the exposure of the image sensor is stopped.

30. A method of monitoring a site comprising:
aiming a non-integrating sensor at the site and exposing pixels of the sensor according to a predetermined sequence to produce analog pixel data;
using a light sensor to produce ambient light level data during each exposure of said pixels; and
adjusting the gain and/or offset of the analog pixel data based on the ambient light level data to correct the analog pixel data for varying ambient lighting at the site.

31. The method of claim 30 further including producing video images for display based on the corrected pixel data.

32. The method of claim 30 in which the site includes a high energy light.

33. An imaging method comprising:
producing analog pixel data by exposing an array of pixels of a logarithmic image sensor according to a predetermined sequence or by exposing said pixels simultaneously; and
adjusting the gain and/or offset of the analog pixel data as it is produced.

34. The method of claim 33 in which the gain and/or offset of the analog pixel data is adjusted as a function of ambient light level data produced by an ambient light level sensor.
